(19) United States
(12) Patent Application Publication
(10) Pub. No.: US 2022/0256762 A1
(43) Pub. Date: Aug. 18, 2022

(54) PIVOTING AND FOLDING TOOLBAR FOR FERTILIZER IMPLEMENT

(71) Applicant: Lynx Ag, LLC, Churdan, IA (US)

(72) Inventor: Lance Glendenning, Churdan, IA (US)

(21) Appl. No.: 17/651,457

(22) Filed: Feb. 17, 2022

Related U.S. Application Data
(60) Provisional application No. 63/200,162, filed on Feb. 18, 2021.

(51) Int. Cl. A01B 73/06; A01B 63/24

(52) U.S. Cl. CPC A01B 73/065; A01B 63/24

(57) ABSTRACT

An agricultural implement can be used to engage a field. Such engagement can be in a number of ways, including, but not limited to, ground engaging, application, drilling, precision agriculture, spreading, spraying, broadcasting, or the like. A number of row units with the engaging tools are positioned along a toolbar extending transversely to the direction of travel. To more easily transport the implement, and to comply with transportation rules and regulations, the toolbar can be folded about wing sections. This can be in multiple directions, including rotationally forward, rotationally vertical, and translationally rearward, which reduces the width of the implement and also minimizes the longitudinal distance between a hitch connecting the implement to a tow vehicle and the transport wheels of the implement.

### CROSS REFERENCE TO RELATED APPLICATIONS

This application claims priority under 35 U.S.C. § 119 to provisional patent application U.S. Ser. No. 63/200,162, filed Feb. 18, 2021. The provisional patent application is herein incorporated by reference in its entirety, including without limitation, the specification, claims, and abstract, as well as any figures, tables, appendices, or drawings thereof.

### FIELD OF THE INVENTION

The invention relates generally the field of agricultural implements. More particularly, but not exclusively, the invention relates to foldable toolbars for agricultural implements that folds and moves wings of a toolbar of an agricultural implement to reduce the length of the tongue of the implement from the hitch to the axle of transport wheels for the agricultural implement.

### BACKGROUND OF THE INVENTION

Agricultural implements perform a number of functions and/or operations. These can include, but are not limited to, applying a particulate material (solid, liquid, or combination) in, or, or around a field and/or crop. The particulate material may be fertilizer (dry or liquid), seed, cover crop, herbicide, or other materials used in the agricultural industry. The application can take many forms, such as broadcasting, spraying, spreading, metered application, planting, or the like. The types of application can depend, at least partly, on the precision needed, mixing, amounts needed, type of crop, type of application, soil type, time of year, and/or other factors that could affect the application process.

The implements can include a toolbar with one or more sections, such as wings, that extend generally longitudinally to the direction of travel for the implement. A number of ground engaging and/or applicating row units can be positioned along the length of the toolbar, including the sections thereof.

However, during transport of the implement, such as between fields or other use locations, the toolbar can be configured to a transport configuration. This can be in a number of ways, such as forward or rear rotating to position one or more wing sections in a parallel manner to the tongue of the implement, vertically rotating one or more wing portions to reduce the width of the transporting implement, lifting and rotating one or more of the wing sections relative to the tongue, or some combination of these. The goal is to have an implement with a wide toolbar to position the row units, while allowing the implement to be reduced during transport for easier movement and/or to comply with rules and/or regulations for using public roads, such as for using the roads to move the implements between fields and/or from a storage location and a field.

However, as the width of the toolbars increases, the lengths of the wing sections likewise increase. Thus, to rotate the wing sections in a forward and/or rearward manner requires extending the distance between the hitch between implement and tow vehicle and the axle(s) of the wheels used to transport the implement.

Thus, there exists a need in the art for systems, methods, and/or apparatus of an agricultural implement to that provides for folding one or more wing sections of an agricultural implement to a transport configuration that reduces the width of the implement and also minimizes the distance of the tongue between the hitch and the transport wheel axle(s).

### SUMMARY OF THE INVENTION

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is a primary object, feature, and/or advantage of the invention to improve on or overcome the deficiencies in the art.

It is a further object, feature, and/or advantage to reduce the width of the tongue of an agricultural implement from the hitch to the transport wheel axles in transport configuration of the implement.

It is still yet a further object, feature, and/or advantage for an agricultural implement to include a toolbar with multiple wing sections to increase the number of row units for the implement, while being folded to reduce the width of the implement.

It is yet another object, feature, and/or advantage to provide a linkage between outer wing sections and an inner wing section to rotate the wing section in a forward manner while moving the wing sections in a rear translational manner to reduce the length between the hitch and the axles.

The apparatus disclosed herein can be used in a wide variety of applications. For example, the wing sections and the foldability thereof can be used for any number of agricultural implements, such as implements with ground engaging and/or applicating row units positioned along a toolbar thereof.

It is preferred the apparatus be safe, cost effective, and durable.

At least one embodiment disclosed herein comprises a distinct aesthetic appearance. Ornamental aspects included in such an embodiment can help capture a consumer's attention and/or identify a source of origin of a product being sold. Said ornamental aspects will not impede functionality of the invention.

Methods can be practiced which facilitate use, manufacture, assembly, maintenance, and repair of the agricultural implement which accomplish some or all of the previously stated objectives.

Aspects and/or embodiments disclosed herein include an agricultural implement with a design that improves on the industry standard in two ways. The first is it reduces the distance between tongue and axle. The industry standard is around 25-feet for a 24-row toolbar. This new design uses an extra joint in the middle of each wing that allows the bar to pivot backwards as it folds in for storage. In practice, this reduces the tongue length by as much as 25%. According to some embodiments, the invention reduces the distance from tongue to axle to approximately 18-feet and 9-inches.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

### BRIEF DESCRIPTION OF THE DRAWINGS

Several embodiments in which the invention can be practiced are illustrated and described in detail, wherein like reference characters represent like components throughout the several views. The drawings are presented for exemplary purposes and may not be to scale unless otherwise indicated.

FIG. 1 is a front perspective view of the agricultural implement of FIG. 1 in the transport configuration.

FIG. 2 is a rear perspective view of an agricultural implement in a transport configuration according to aspects and/or embodiments of the invention.

FIG. 3 is a top plan view of the agricultural implement of FIG. 1 in the transport configuration.

FIG. 4 is a rear elevation view of the agricultural implement of FIG. 1 in the transport configuration.

FIG. 5 is a front elevation view of the agricultural implement of FIG. 1 in the transport configuration.

FIG. 6A is a side elevation view of the agricultural implement of FIG. 1 in the transport configuration.

FIG. 6B is a side elevation view similar to FIG. 5A, but without transport wheels.

FIG. 7 is a view of an agricultural implement in a field use configuration before moving towards a transport configuration.

FIG. 8 is another view of the agricultural implement moving from field use configuration to a transport configuration.

FIG. 9 is another view of the agricultural implement moving from a field use configuration to a transport configuration.

FIG. 10 is a view of the agricultural implement moving from a field use configuration to a transport configuration.

FIG. 11 is a view of the agricultural implement in a transport configuration.

An artisan of ordinary skill need not view, within isolated figure(s), the near infinite number of distinct permutations of features described in the following detailed description to facilitate an understanding of the invention.

### DETAILED DESCRIPTION OF THE INVENTION

The present disclosure is not to be limited to that described herein. Mechanical, electrical, chemical, procedural, and/or other changes can be made without departing from the spirit and scope of the invention. No features shown or described are essential to permit basic operation of the invention unless otherwise indicated.

Unless defined otherwise, all technical and scientific terms used above have the same meaning as commonly understood by one of ordinary skill in the art to which embodiments of the invention pertain.

The terms “a,” “an,” and “the” include both singular and plural referents.

The term “or” is synonymous with “and/or” and means any one member or combination of members of a particular list.

The terms “invention” or “present invention” are not intended to refer to any single embodiment of the particular invention but encompass all possible embodiments as described in the specification and the claims.

The term “about” as used herein refer to slight variations in numerical quantities with respect to any quantifiable variable. Inadvertent error can occur, for example, through use of typical measuring techniques or equipment or from differences in the manufacture, source, or purity of components.

The term “substantially” refers to a great or significant extent. “Substantially” can thus refer to a plurality, majority, and/or a supermajority of said quantifiable variable, given proper context.

The term “generally” encompasses both “about” and “substantially.”

The term “configured” describes structure capable of performing a task or adopting a particular configuration. The term “configured” can be used interchangeably with other similar phrases, such as constructed, arranged, adapted, manufactured, and the like.

Terms characterizing sequential order, a position, and/or an orientation are not limiting and are only referenced according to the views presented.

The “scope” of the invention is defined by the appended claims, along with the full scope of equivalents to which such claims are entitled. The scope of the invention is further qualified as including any possible modification to any of the aspects and/or embodiments disclosed herein which would result in other embodiments, combinations, subcombinations, or the like that would be obvious to those skilled in the art.

Referring now to the figures, an agricultural implement 10 is provided. As noted, agricultural implements can be used for a variety of agricultural operations. These can include, but are not limited to, ground engaging applications, which can include, planting, spreading, broadcasting, drilling, tilling, fertilizer application, plowing, or the like. For example, the implement may be towed by a tractor or other tow vehicle across a field. A number of ground engaging units, such as row units spaced along the implement, may be used to complete one or more of the agricultural operations listed herein. In some instances, the implement includes one or more toolbars that extends transversely, perpendicularly, or otherwise in a non-parallel manner relative to the direction of travel for the implement and tow vehicle and/or a tongue connecting the implement to the tow vehicle.

To speed the process for completing one or more of the agricultural operations, the toolbar(s) of the implement can be increased in length to be able to mount more row units for completing the operations. This increases the width of the implement, which can be prohibitive for transporting the implement outside of a field. For example, the implements will need to be transported from field to field, storage to field, field to storage, or otherwise traveling on roads or areas outside the field. As these roads are controlled by local and/or federal travel regulations, such as related to weight, width, height, or the like, the implements need to be able to comply with such regulations.

Therefore, many of the implements include ways to adjust between field use and transport configurations. This can include, for example, forward rotating/folding of wings of the implement, rearward rotating/folding of wings of the implement, vertical rotation of one or more wings of the implement, or lift and rotate of one or more portions of the implement toolbar.

The implement 10 as shown and described provides for a novel approach for moving wings of a toolbar from a field use configuration where the wings form a part of a toolbar that extends generally perpendicular to the tongue of the implement to a transport configuration where the wings are generally parallel to the tongue. In addition, as will be understood, the novel features of the implement provide additional advantages. This includes a reduction, compared to known implements, in the length of the distance of the implement between the hitch connecting the implement to the tow vehicle and the axles of the wheels of the implement used for transporting the same in the transport configuration. As will be understood, aspects of the invention will provide for an approximately 25% reduction in the length between hitch and wheel axles for an implement. This provides greater control and stability for the system, while maintaining the desired width of the toolbar so as to allow maximum positioning of a number of ground engaging row units.

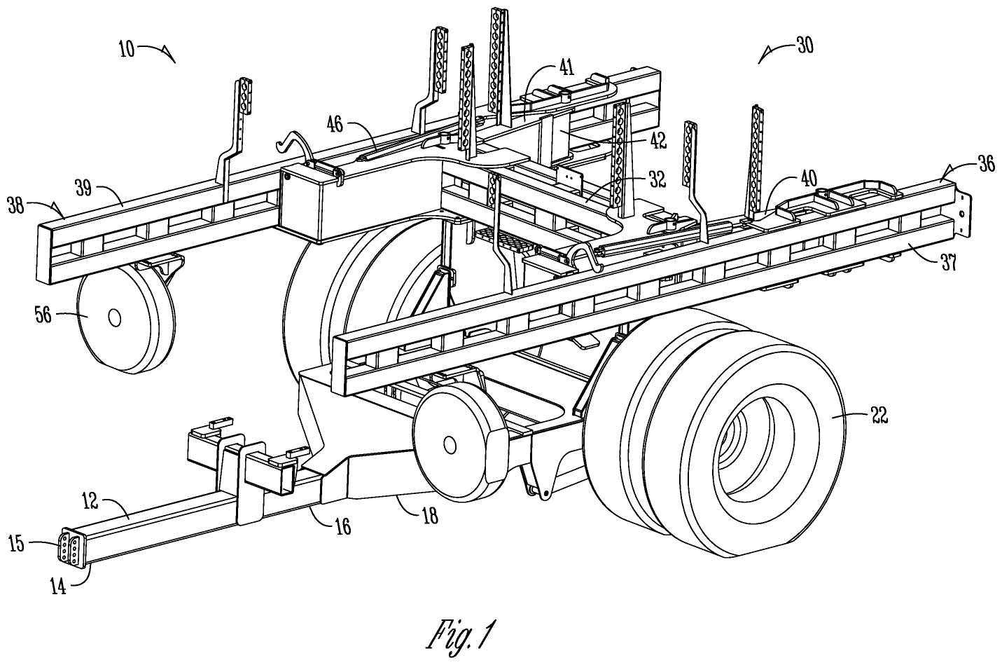

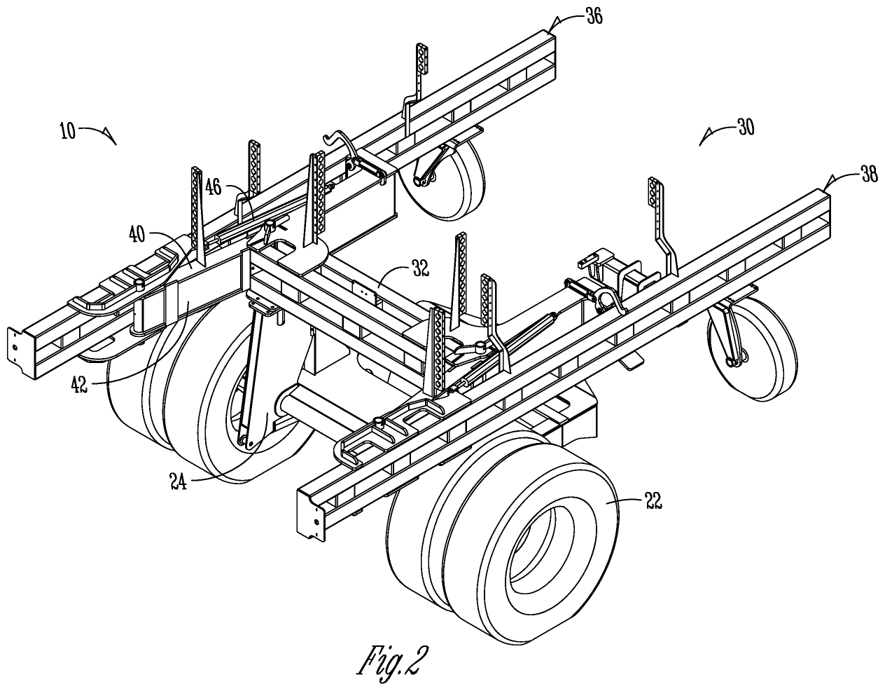

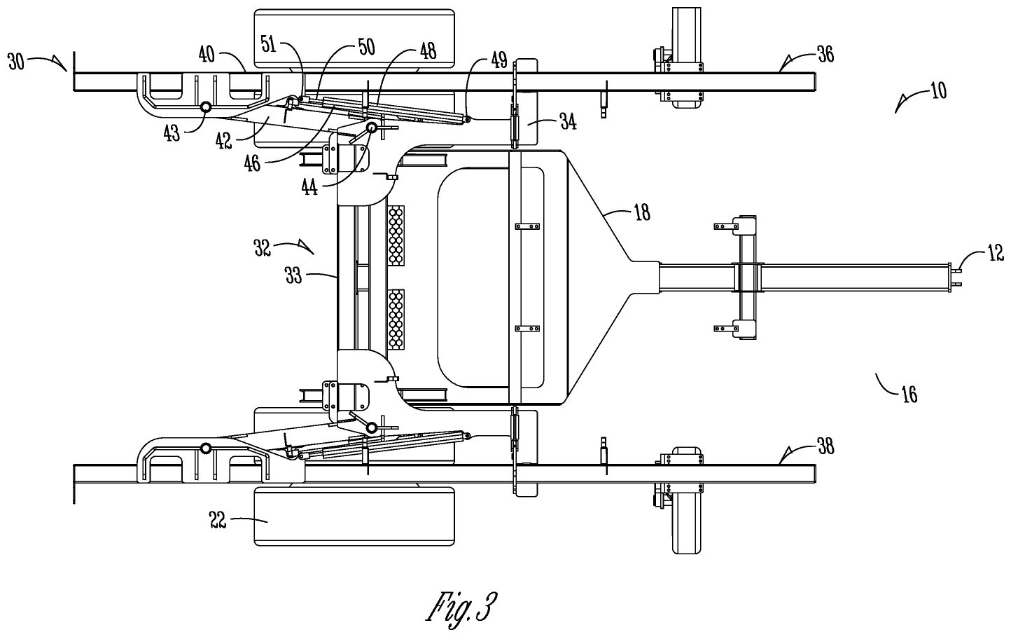

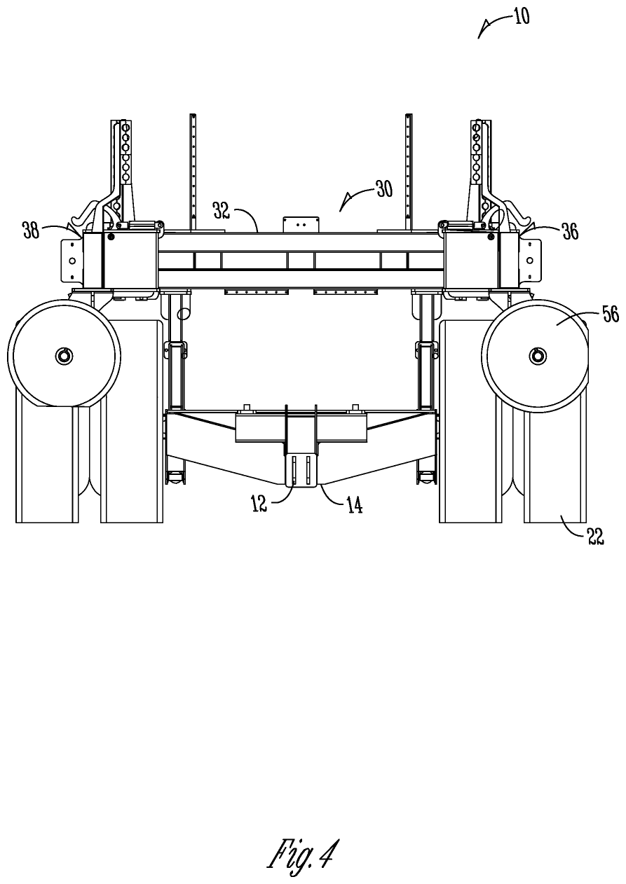

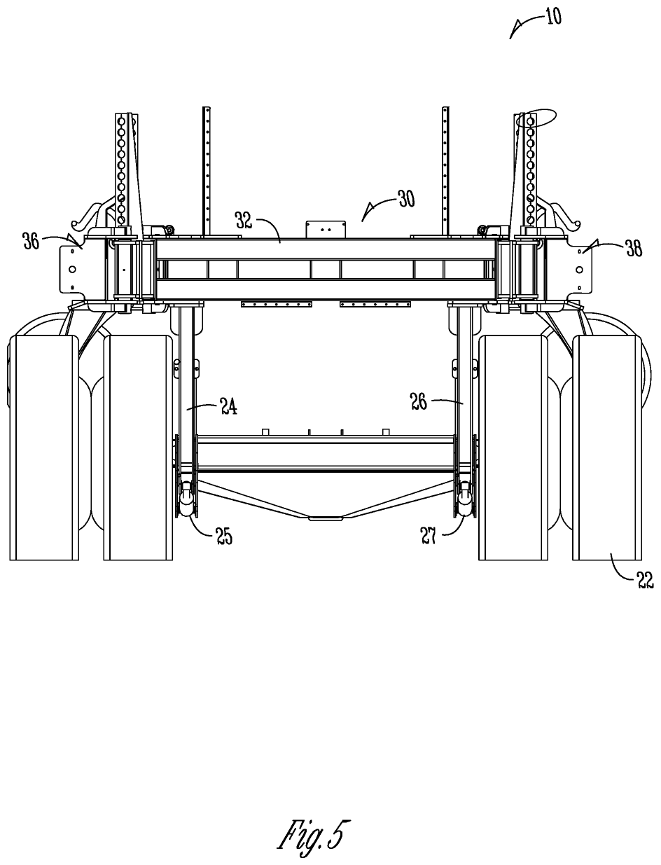

As shown in FIGS. 1-6B, an agricultural implement 10 is shown in a transport configuration. The implement 10 includes a tongue 12. The tongue 12 includes a first end 14 including a hitch or other connecting member 15, which is used to connect the implement 10 to a tow vehicle, such as a tractor (not shown). The tongue 12 extends generally in a longitudinal direction of the direction of travel, but is allowed to swivel or otherwise rotate relative to the tow vehicle as it turns.

The tongue 12 includes a second end 16 opposite the first end 14. At the second end 16 is a frame portion 18 in the figures. However, this is not required in all embodiments. Additionally, at the second end 16 is a toolbar 30, which will be explained herein.

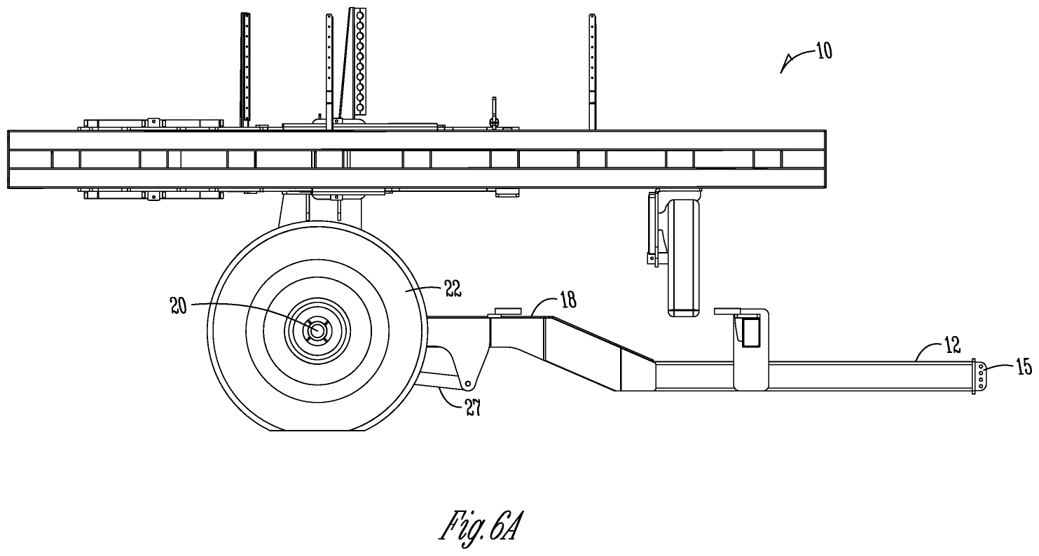

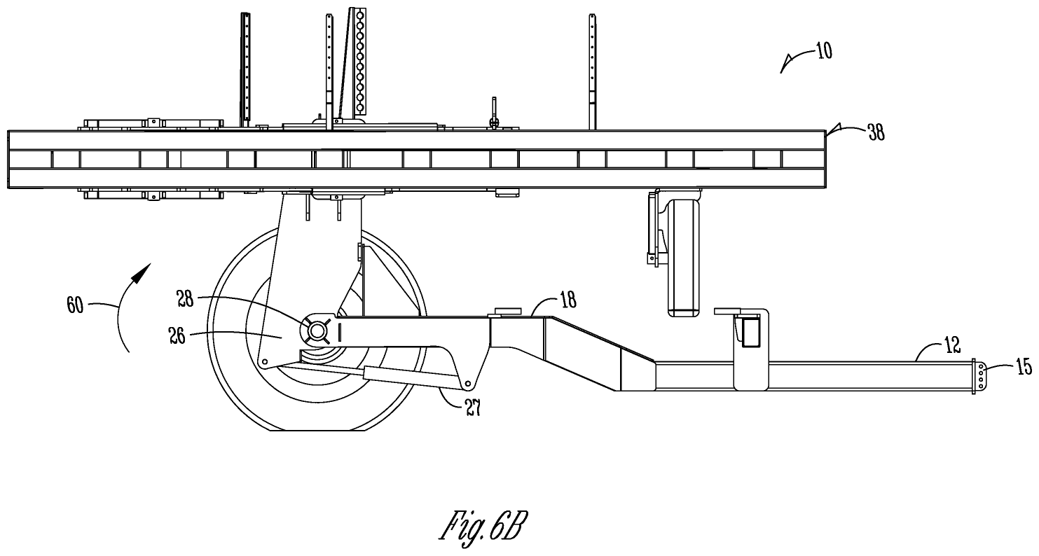

Also positioned generally at or near the second end 16 of the tongue 12, and shown to be connected generally to the frame 18 in the figures, are wheels 22. The wheels 22 may also be referred to as transport wheels, and are used to move the implement in and out of a field. Furthermore, it should be appreciated that the wheels could be replaced with tracks or other ground movers, and all are to be considered to be a part of the disclosure. As best shown in FIG. 6A, the wheels 22 rotate about an axle 20 that extends through a portion of the frame 18 of the tongue 12.

As has been included, it is preferable to minimize the length of the tongue 12, which may be considered the distance between the hitch 15 and the axle 20 of the transport wheels 22. This may depend, in part, on the width or length of the toolbar 30, as will be understood, as the toolbar 30 will include outer wing sections 36, 38 that are rotatably folded to be substantially parallel to the tongue 12, such as shown in the figures. This is the transport configuration of the implement.

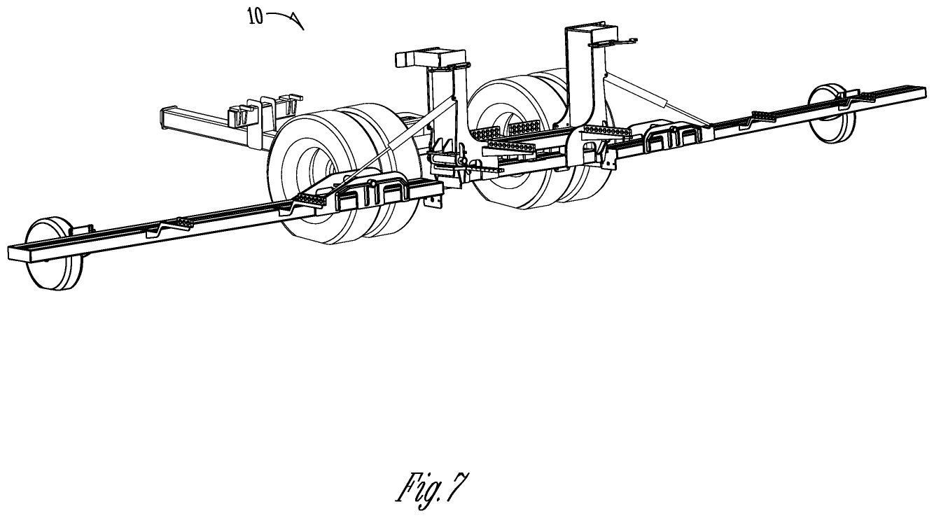

As noted, a toolbar 30 extends at the second end of the tongue 12. The toolbar 30 as shown in the figures include multiple portions. These are referred to as a center boom/wing 32, first outer wing 36, and a second outer wing 38. The center boom 32 is a portion of the toolbar 30 generally behind or otherwise in line with the tongue 12, and includes a center toolbar portion 33 and a frame portion 34. Row units or other ground engaging units are attached and positioned along the toolbar portion 33. The first and second outer wings 36, 38 extend generally outwardly from the center boom 32. This is in a direction generally perpendicular to the tongue in the field use configuration, such as best shown in FIG. 7. However, as will be understood, the wings 36, 38 are rotatably connected to the center boom 32 such that the outer wings are able to rotate in a folded manner to the transport configuration wherein the other wings 36, 38 are substantially parallel to the tongue 12. The outer wings 36, 38 also include toolbar portions 37, 39. A number of ground engaging components/row units can be spaced along the lengths of the outer wing toolbars 37, 39. In addition, other components, such as including, but not limited to, fans, hydraulics, electronics, conduits, markers, sensors, motors, motor controllers, or the like, can also be positioned along any of toolbar portions. As shown in the figures, toolbar wheels 56 are shown along the lengths of the outer wings, which can contact the ground when in the field use configuration (see, e.g., FIG. 7).

The outer wings 36, 38, as disclosed, are generally connected to the center boom 32 via rotatable linkages 40, 41, with the first linkage 40 connecting the first outer wing 36 and the second linkage 41 connecting the second outer wing 38. The wings and linkages are generally mirror images of one another, and therefore, will be described with respect to one side, with the understanding that the other side will include similar components and operate in generally the same manner.

As shown in the figures, the linkage 40 includes a transition arm 42 and an actuator 46 connecting the first outer wing 36 to the frame portion 34 of the center boom 32. The transition arm 42 is a member of fixed length and being connected at a first pivot point 43 to the outer wing 36 and a second pivot point 44 at the center frame 34. The actuator 46 may be generally any type of actuator, including, but not limited to hydraulic actuator, pneumatic actuator, electric linear actuator, electro-hydraulic actuator, or some combination thereof. The type of actuator is not to be limiting to the disclosure. The actuator as shown includes a housing 48 connected at a pivot point 49 to the frame 34 and a rod portion 50 connected at a pivot point 51 at the outer wing 36. However, this could be reversed, as well.

The linkages 40, 41 connecting the outer wings 36, 38 to the center boom 32 provide numerous advantages. The linkages allow the outer wings to be rotatable in a forward manner about a substantially vertical number of axis to position the outer wings in the configuration of the figures in the transport configuration. In addition to the forward rotation, the linkages will also provide some translational movement of the wings in the rearward direction relative to the direction of travel for the implement. The rearward movement will reduce the distance needed to compensate for the length of the outer wings, which will reduce the overall length from the hitch to the wheel axles.

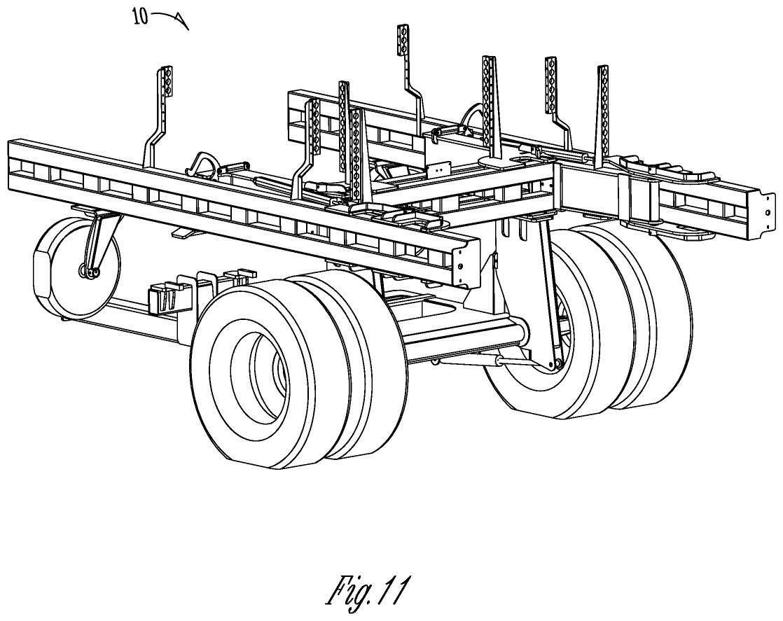

In operation, when moving from the field use configuration (see, e.g., FIG. 7) to the transport configuration (see., e.g., FIG. 1 or 11), the actuators will begin retraction of the rods 50. This will begin forward rotation of the outer wings toward the tongue 12. As the wings rotate forward, the transition arms 42 will limit the rotation without further rearward movement of the linkage. Thus, continued retraction of the actuator will translate the wing rearwardly as well as rotating in a forward direction. Such a movement will convey a portion of the outer wings to extend beyond the rear of the implement 10, reducing the distance needed between the wheel axles 20 and the hitch 15.

In addition to the forward rotation and rear translation of the wings, and prior to such movement, the toolbar 30, including the center boom 32 and both outer wings 36, 38, are rotated upward about a substantially horizontal axis 28, such as in the direction of the arrow 60 in FIG. 6B. The center boom, including either or both of the frame portion 34 or the toolbar 33, is rotatably connected to the tongue 12 at the second end thereof, such as via the frame 18 positioned at the second end 16 of the tongue. As shown in the figures, the rotatable connection axis may be similar to or the same as the axle 20 for the transport wheels 22. At the connection point, first and second pivots 24, 26 include pivoting connection point to the frame 18. Another portion of the pivots is connected to the center boom 32. As shown in the figures, this is a static or fixed connection. An actuator 27 is also connected to each of the pivots such that each pivot includes its own actuator connected thereto. The actuator 27 is rotatably connected at a first end to the pivot (such as the rod in FIG. 6B) and at a second end to the frame 18 (such as at the housing in FIG. 6B). The pivots, actuator, and frame members create a linkage for movement of the toolbar 30 based upon movement of the pivots. Thus, the extension and/or retraction of the actuators will cause the pivots 24, 26 to rotation about the pivot axis 28, which will also cause a rotation of the toolbar 30 about the pivot axis 28. The actuators can be reversed in orientation as needed or otherwise desired.

In operation, when moving from the field use configuration (see, e.g., FIG. 7) to the transport configuration (see., e.g., FIG. 1 or 11), the actuators 27 extend the rods, which rotate the pivots about the pivot axis 28. This will rotate the toolbar 30 as well, such as shown by the arrow 60 in FIG. 6B. According to some aspects and/or embodiments of the disclosure, the toolbar 30 will rotate approximately 90-degrees between the field use configuration and the transport configuration. However, it should be appreciated that any amount of rotation is envisioned to be part of the disclosure. For example, the rotational lifting may be substantially less than 90-degrees before the outer wings are rotated, or may be more than 90-degrees, even slightly. For example, the rotational lifting may be needed enough to provide clearance for any of the row units or other ground engaging components of the implement 10, or clearance for the wing wheels 56 as shown in the figures.

FIGS. 7-11 show iterative movements of the implement 10 with the components shown and/or described herein through an exemplary process of moving from the field use configuration (FIG. 7) to the transport configuration (FIG. 11). As shown in FIG. 7, the implement 10 is in the field use configuration in which the toolbar 30 is lowered and the outer wings extended transversely to the tongue. This allows a number of components, row units, and/or ground engaging tools to be positioned and operated by the toolbar 30.

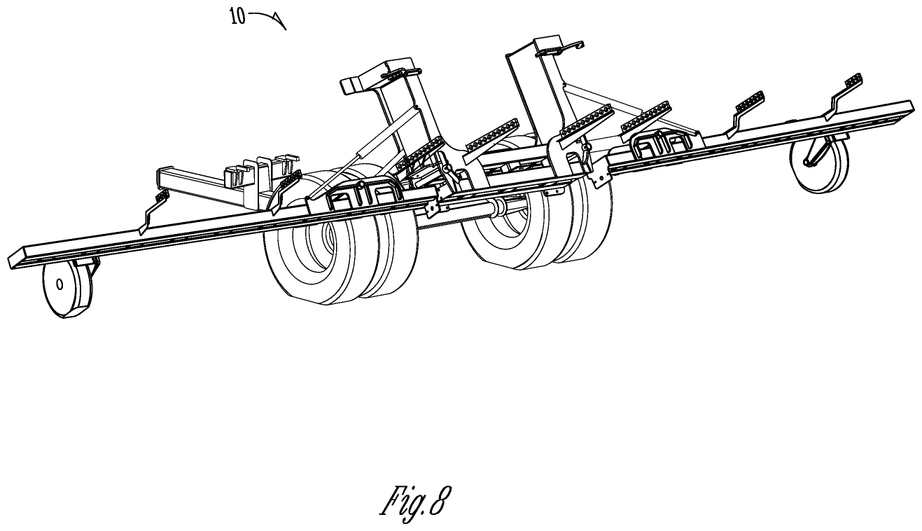

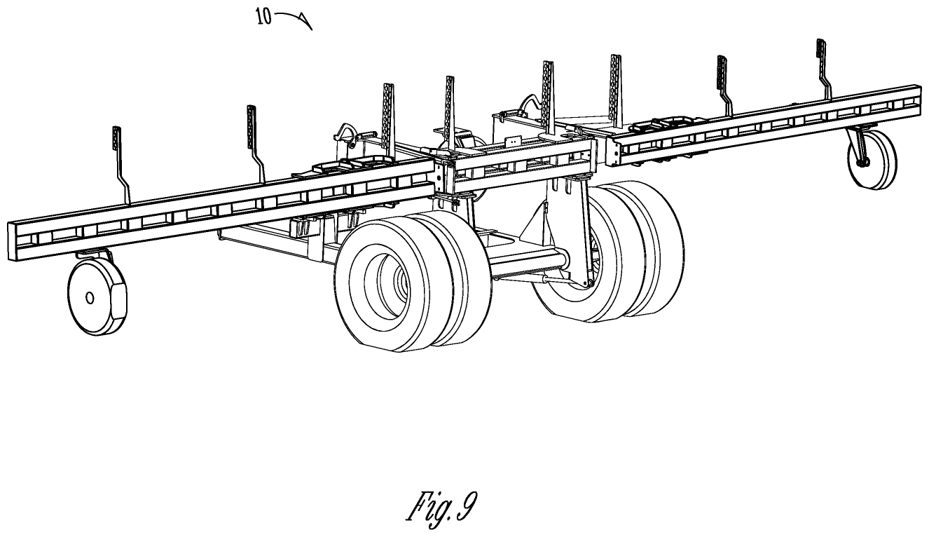

As shown in FIG. 8, the actuators 25, 27 have started to extend, which rotate the pivots 24, 26. This rotation causes the toolbar 30 to begin rotating upwardly, thus lifting the toolbar 30. The upward rotation continues until the configuration shown in FIG. 9, wherein the toolbar 30 has been lifted and the actuators have been extended. As noted, this upward rotation provides clearance for the toolbar and associated components.

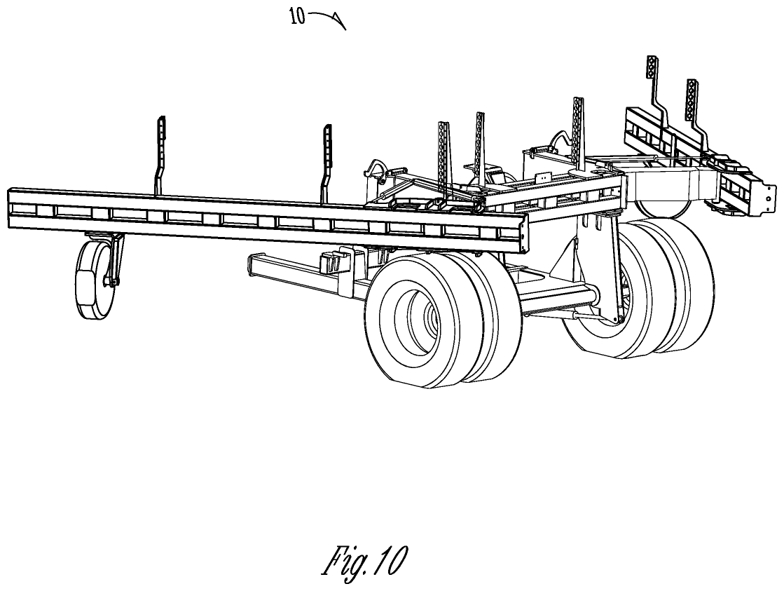

Next, in FIG. 10, the wing actuators 46 have begun to retract, which begins operation of the forward rotation of the outer wing sections 36, 38. As noted, the retraction and linkage members (e.g., actuator and transition member) will rotate the wings in a forward manner until such time that the linkage will also move the outer wing sections translationally rearward. This is continued until the wings are positioned in the transport configuration shown in FIG. 11.

As noted, the movement of the wings about the linkage members will reduce the distance of the tongue, and specifically the distance between the hitch and the wheel axles. This will allow a shorter distance to be used than then lengths of the outer wings. For example, it is industry standard for a tongue distance (distance from hitch to axle) to be around 25-feet for a 24-row toolbar. The implement and components shown and/or described use an extra joint in the middle of each wing that allows the outer wings to pivot backwards as they fold forward for transport/storage. In practice, this reduces the tongue length by as much as 25%. According to some embodiments, the invention reduces the distance from hitch to axle to approximately 18-feet and 9-inches. The reduction of length provides greater control and stability for the implement, particularly when the implement is transported. The shorter distance will allow for easier turning of the implement by the tow vehicle and will also increase the safety of the tow vehicle and implement as the combination travels down roads.

It should be appreciated that, while the terms forward, rearward, direction of travel, lifting, or other directional terms have been provided, it is to be appreciated that these terms are to be viewed generally as if the implement were being used for its normal, intended purpose, and on substantially flat elevation ground. As the implement moves along varying topographies and elevations, these terms may not exactly be the same as intended with respect to flat elevations, however, this will not change the understanding and/or disclosure herein.

Therefore, an agricultural implement has been provided that allows for easy and controlled movement between field use and transport configurations. The toolbars provided can take different forms and/or lengths, and can be separated into additional portions as well as those shown herein. Additional variations, replacements, and/or alternatives to any or all of the components shown and/or described should be considered a part of the invention and obvious to those skilled int the art. From the foregoing, it can be seen that the invention accomplishes at least all of the stated objectives.

1. An agricultural implement, comprising:
a tongue comprising a hitch at a first end and one or more transport wheels at a second end;
a toolbar at the second end of the tongue, said toolbar extending substantially perpendicular to the tongue in a field use configuration, the toolbar comprising:
a center wing section;
first and second outer wing sections extending outward from opposite sides of the center wing section in the field use configuration; and
a linkage between each of the outer wing sections and the center wing section, said linkage operable to rotate the outer wing sections forward about a substantially vertical axis and also translating the outer wing sections in rearward direction.

2. The agricultural implement of claim 1, further comprising at least one actuator between the tongue and the center wing section to rotate the toolbar about a substantially horizontal axis.

3. The agricultural implement of claim 2, wherein the substantially horizontal axis of rotation for the toolbar extends substantially perpendicular to the length of the tongue.

4. The agricultural implement of claim 3, wherein extension of the actuator rotates the toolbar vertically about the horizontal axis of rotation.

5. The agricultural implement of claim 1, wherein the linkage between each of the outer wing sections and the center wing section comprises an extendable actuator and a fixed length arm each rotatably connected to the outer wing section and the center wing section.

6. The agricultural implement of claim 5, wherein retraction of the actuator of the linkage rotates the outer wing section forward toward the tongue.

7. The agricultural implement of claim 1, wherein the outer wing sections comprise wing wheels.

8. The agricultural implement of claim 1, wherein the center wing section comprises a frame.

9. The agricultural implement of claim 8, wherein the linkage is connected between the outer wing sections and the frame of the center wing section.

10. The agricultural implement of claim 1, wherein the first and second outer wing sections are substantially parallel to the tongue in the transport configuration.

11. An agricultural implement, comprising:
a tongue comprising a hitch at a first end and one or more transport wheels at a second end;
a toolbar at the second end of the tongue, said toolbar extending substantially perpendicular to the tongue in a field use configuration, the toolbar comprising:
a center wing section; and
first and second outer wing sections extending outward from opposite sides of the center wing section in the field use configuration; and
a toolbar rotation system comprising:
a center linkage including an actuator to rotate the toolbar about a generally horizontal axis; and
first and second wing linkages including actuators to rotate the first and second outer wing sections relative to the center wing section.

12. The agricultural implement of claim 11, wherein the toolbar further comprises a transport configuration.

13. The agricultural implement of claim 12, wherein in the transport configuration, the first and second outer wings are substantially parallel to the tongue.

14. The agricultural implement of claim 13, wherein in the transport configuration, the first and second outer wings include a portion extending rearward of the center wing section.

15. The agricultural implement of claim 11, wherein the first and second wing linkages rotate the first and second outer wings about a substantially vertical axis.

16. The agricultural implement of claim 11, wherein the first and second outer wing sections are substantially parallel to the center wing section during rotation of the center linkage.

17. A method of moving an agricultural implement from a field use configuration to a transport configuration, the method comprising:
rotating a toolbar, including a center section and first and second outer wing sections, about a substantially horizontal axis approximately 90-degrees to raise the toolbar;
after the toolbar has been raised, rotating the first and second outer wing sections about substantially vertical axes until the first and second wing sections are substantially parallel to one another and substantially perpendicular to the center wing section.

18. The method of claim 17, wherein the first and outer wing sections are rotated in a manner in which a portion of the wing sections move rearwardly behind the center wing section.

19. The method of claim 17, further comprising extending an actuator to rotate the toolbar to the raised position.

20. The method of claim 19, further comprising retracting an actuator to rotate the outer wing sections.
